(19) United States
(12) Patent Application Publication
(10) Pub. No.: US 2005/0286263 A1
(43) Pub. Date: Dec. 29, 2005

(54) Plasma lamp with light-transmissive waveguide

(76) Inventors: David A. Champion, Lebanon, OR (US); Ted W. Barnes, Corvallis, OR (US); Alexander Govyadinov, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/876,293

(22) Filed: Jun. 23, 2004

(51) Int. Cl. F21V 11/00; F21V 7/04

(52) U.S. Cl. 362/558; 362/582

(57) ABSTRACT

A lamp may include a waveguide having a solid dielectric body and may have a bulb disposed in the body. The bulb may be adapted to produce light when excited by the electromagnetic energy. The waveguide body may have at least a portion that is transmissive of light. The waveguide may be configured to guide electromagnetic energy received from a source, and may have one or more apertures adapted to allow light to exit the waveguide body.

### BACKGROUND

Plasma lamps provide intense light produced from ionized gas. A waveguide containing a bulb receives microwave electromagnetic energy from a source. Substances in the bulb form plasma when in the presence of sufficient energy. In some plasma lamps, the waveguide has a solid dielectric. The bulb is positioned at the edge of the waveguide so that light can be emitted from the waveguide through a window. In other plasma lamps, the waveguide is gas filled and a light reflector disposed around the waveguide directs light away from the bulb.

### BRIEF DESCRIPTION OF THE DRAWINGS

FIG. 1 is a block diagram of a plasma lamp system according to an embodiment of the invention.

FIG. 2 is a cross-section of a plasma lamp according to another embodiment of the invention.

FIG. 3 is a graph illustrating an exemplary mapping of relative output to input power ratio for an ellipsoid resonance waveguide useable for a plasma lamp, as illustrated in FIG. 2.

FIG. 4 is a cross-section of a plasma lamp according to yet another embodiment of the invention.

FIG. 5 is a cross-section of a plasma lamp according to another embodiment of the invention.

### DETAILED DESCRIPTION

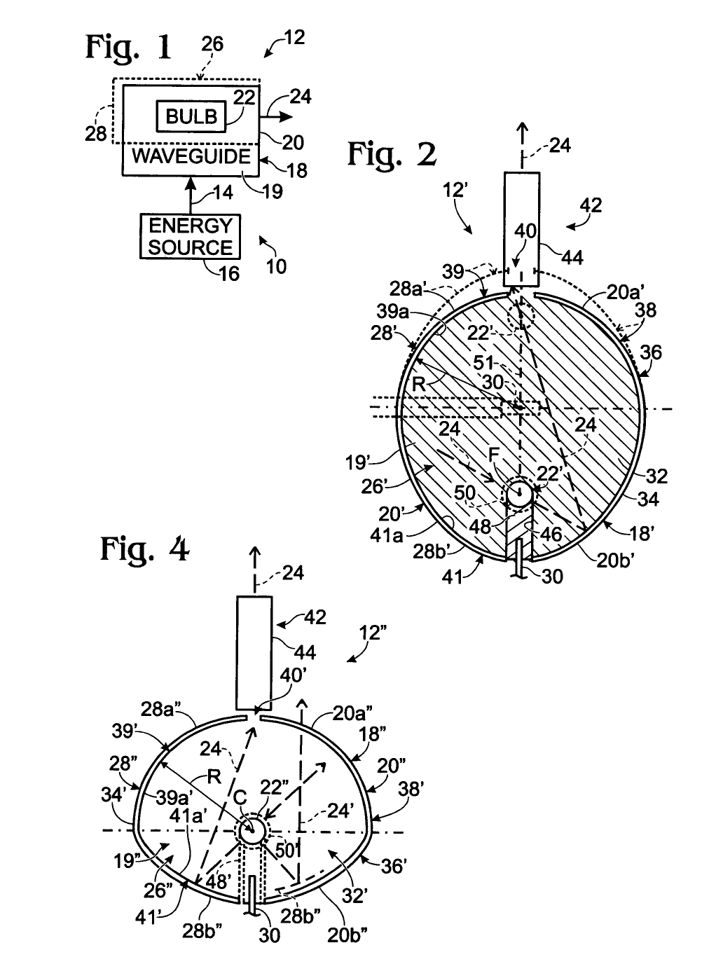

FIG. 1 depicts a block diagram of a plasma lamp system, shown generally at 10. System 10 may include a plasma lamp 12 that is adapted to receive electromagnetic energy 14 from an energy source 16. Lamp 12 may include a waveguide 18 having a body 19 defining a perimeter 20 within which a bulb 22 is disposed. Bulb 22 contains a gas-fill that forms plasma and emits light when excited by sufficient electromagnetic energy. Light 24 produced by the bulb is transmitted out of the waveguide.

Any electromagnetic energy 14 that is suitable and sufficient to produce plasma in bulb 22 may be used. For example, electromagnetic energy may include one or more of radio frequency (RF) energy, sub-infrared energy, microwave energy, millimeter-wave energy, light (infrared, visible or ultraviolet) energy, and x-ray energy. In some examples, energy in the range of 1 gigahertz (GHz) to 10 GHz may be used. Energy with a single frequency, multiple frequencies, and varying or constant phase, amplitude, and frequency may be used.

The electromagnetic energy 14 may be transmitted to waveguide 18 by any appropriate transmission link, such as by a coplanar, planar or coaxial transmission line, a connecting waveguide, a wireless transmission link, or a combination of such links. The energy may be transmitted with or without conversion in form or frequency at the source 16, along the transmission link, or at the lamp waveguide 18.

Resonance produces high relative power that may be coupled to bulb 22 for exciting plasma formation in the gaseous envelope. Waveguide 18 may be dimensioned to produce resonance of the received energy 14 in a particular mode of resonance, such as a transverse electric (TE) or a transverse magnetic (TM) mode. A bulb may be positioned at or near a point of resonance. In a fundamental mode, resonance may occur when a dimension of the waveguide corresponds to an integral multiple of one-half of the wavelength of a frequency of the applied energy in the dielectric or dielectrics forming body 19. A waveguide in which resonance occurs may also be referred to as a resonant cavity or a resonator.

The bulb 22 may be a small chamber filled with an appropriate gas, such as a noble gas. A second element or compound may be included to provide light in a desired frequency range. For example, light may be produced that is in one or more of the infrared, visible and ultraviolet frequency ranges.

The bulb may also be positioned where appropriate to provide for outputting of the produced light from the waveguide. The bulb may be positioned in a light-transmissive chamber 26 that may be bounded by a light-chamber perimeter 28. Chamber 26 may be coextensive with, overlap, be contained within, or contain the waveguide. The bulb may be in both the waveguide 18 and the light-transmissive chamber 26. The shapes and/or sizes of the waveguide and light-transmissive chamber may be different. In an example in which the waveguide and light-transmissive chamber are coextensive, the bulb may be positioned along the waveguide perimeter or within the waveguide, spaced from the perimeter. One or more bulbs may be used at a location or locations that may correspond to a local energy peak or peaks, or other position suitable for igniting and maintaining plasma in the bulb or bulbs, such as at a resonant energy peak.

The waveguide dielectric body 19 may include one or more gases (including air and vacuums), liquids, and solids, and combinations of two or more of these dielectrics. Dielectrics with higher dielectric constants allow the waveguide to have smaller dimensions while providing resonance. Examples of solid materials suitable for dielectrics include alumina, zirconia, titanates, and variations and combinations of these materials. Other examples that may include a further characteristic of being light transmissive may include such materials as silicone oil, sapphire, zirconia, magnesia, or any transparent or other light transmissive dielectric. Porous materials or materials that may be made porous, such as aerogel, silica, alumina, zirconia and the like, may also be used.

Light produced by the bulbs may be transmitted out of the waveguide. A bulb may be positioned next to a window in the waveguide, or may be spaced from a window. Light produced by a bulb may be transmitted along one or more light-transmissive mediums extending directly or indirectly between the bulb and a waveguide window or aperture.

Many variations in the shapes of waveguide 18 and light-transmissive chamber 26 may be used. FIGS. 2, 4 and 5 depict three sets of examples of shapes that may be used for plasma lamps. These figures primarily illustrate waveguides and light-transmissive chambers with continuously curved perimeters. Depending on the embodiments, other configurations may also be used. For example, waveguides may have a combination of flat surfaces, such as a box-shape, a combination of flat and curved surfaces, such as a cylinder with flat ends or a parabola with a flat end, or continuous curved surfaces, such as a cylinder with curved ends, a sphere, a combination of a hemisphere and a portion of an ellipsoid or parabaloid, or other suitable regular or irregular shapes. In these figures, additional, alternative or optional embodiments of features may be identified with the same reference number, with or without one or more primes, such as 28a, 28a′, 28a″, and 28a′″. These various embodiments may also be referred to collectively by use of the base reference number, such as 28a in this example.

FIG. 2 in particular depicts a plasma lamp 12′ adapted to be used in a lamp system 10. Lamp 12′ may include a waveguide 18′ having a body 19′ with a perimeter 20′, and a bulb 22′. Electromagnetic energy from a source may be coupled to waveguide 18′, such as by an energy feed 30. More than one energy feed from one or more energy sources and more than one bulb may be used. Each feed and bulb may be placed at any respective location appropriate in view of the geometry of the waveguide, the frequency or frequencies of energy applied, and the relative locations of the feeds and bulbs. For example, an optional feed position might be the center of the waveguide or the center of an end section, such as at the center of the hemispherical perimeter portion 20a′, as represented by the feed 30 shown in dashed lines and extending in from a side of the waveguide.

In this example, body 19′ may include a solid dielectric 32 that also transmits light. Waveguide body 19′ and light-transmissive chamber 26′ thus may be coextensive. For example, dielectric 32 may be sapphire, which may have a dielectric constant, k, greater than 9, making the waveguide body smaller than if the dielectric constant was lower, as in the case of air. The waveguide may also be gas filled or be filled partially or completely with a porous dielectric, such as aerogel, fibrous silica, alumina, zirconia, or the like to facilitate heat removal by airflow through the dielectric. A liquid-filled waveguide may allow for the use of conductive or convective cooling. Dielectric 32 also may be formed of a plurality of different dielectric portions, which may be one or more of a solid, a liquid, a gas, a light transmissive material, and a light non-transmissive material. Light-transmissive chamber 26′ may also be one or a combination of electromagnetic energy conductive materials and electromagnetic energy non-conductive materials, depending on the particular application and configuration desired.

Perimeter 20′ may be defined by a boundary 34 that may be reflective of one or both of light, whether infrared, visible, or ultraviolet, and electromagnetic energy. Boundary 34 thereby may function as a waveguide shield 36 with waveguide perimeter 20′, as a light shield or director 38 with light perimeter 28′, or as both a waveguide shield and a light shield. Director 38 may also include additional elements within light-transmissive chamber 26′.

A waveguide shield 36 may be any suitable material that reflects or guides electromagnetic energy. For example, it may be a continuous conductive material, such as solid metal, or discontinuous conductive materials, such as a solid metal with apertures, a metal mesh or a screen. Discontinuous materials may have regularly or irregularly spaced apertures, such as apertures between lines of criss-crossing wires forming a mesh. A waveguide shield, such as a mesh, may be a hot mirror in that it reflects electromagnetic energy and transmits (is transparent to) light. A light director affects the transmission of light, and may include one or more light director elements, such as reflective elements, refractive elements, and filters. A director functioning as a reflector, such as a thin metal coating, may be a cold mirror in that it reflects light and transmits electromagnetic energy.

Optically highly reflective, thin metal coatings may be used for light director 38 forming light perimeter 28′. Highly reflective coatings may be non-transparent and reflective of light emitted from the bulb. For example, for broad spectrum visible light, the coating may reflect light having wavelengths in the range of 0.4 and 0.7 micrometers. In embodiments in which it is desired to have electromagnetic waves, such a radio frequency (RF) waves, microwaves, and millimeter waves, pass through it, a coating may be used that is transparent to such waves. The bulbs may be very hot, such as high as 1000° C., and the coating may tolerate high temperatures. In order to assist in removing heat from the lamp, high thermal conductivity may be desirable. Such coatings may be in an appropriate form, such as a thin metal having a skin effect, a thin metal coating with a dielectric reflective coating, and a highly reflective dielectric coating.

A dielectric coating may also have broad light spectrum reflectivity, such as reflectivity over a wavelength range of 0.35 to 0.8 micrometers, for example. As a further example, a dielectric layer may be used that has a thickness approximately equal to one quarter of a wavelength of applied electromagnetic energy, formed as a laminate of multiple dielectric layers, including light-reflective layers. A reflective dielectric coating can be used that is reflective of the desired range of light frequencies produced by the bulb. Metal mirrors enhanced with thin dielectric films may be used. Such overcoatings may be made more durable with the use of protective dielectric layers that have an appropriate thickness, such as a thickness approximately an integral number of half-wavelengths of a selected optical frequency to be reflected.

In the embodiment shown, perimeters 20′, 28′ include partial spherical portions 20a′, 28a′ having a common generally hemispherical shape with a radius R. The perimeters may also include non-spherical portions 20b′, 28b′. In some examples, portions 20b′, 28b′ form a partial generally ellipsoid, paraboloid, or other shape. As has been mentioned, the metal coating forms the light director 38. Accordingly, the portion of the metal coating (or other reflective or refractive device) corresponding to light chamber perimeter portion 28a′, forms a light directing element 39 having a reflective surface 39a. Similarly, the portion of the metal coating corresponding to perimeter portion 28b′ forms a directing element 41 having a reflective surface 41a.

One or more apertures, such as aperture 40, may allow for the transmitting of light out of waveguide 18′. Optical directors 42, such as an integration rod 44, may further process the light 24 after it exits cavity waveguide 18′. Other forms of optical devices, such as lenses, filters and reflectors, may also be included.

A bulb 22′ may be positioned within waveguide 18′ at about an optical focal point F of non-spherical portion 28b′. This non-spherical portion may be adapted to direct light produced by bulb 22′ toward aperture 40. Other configurations and orientations may also be provided. In an example in which portion 28b′ includes a partial ellipsoid or paraboloid shape with bulb 22′ located at an optical focal point, light reflected from the perimeter portion 28b′ may be directed in a common, parallel direction. In an embodiment in which upper portion 28a′ is not reflective of light, then this light would form a wide beam directed upwardly, as viewed in FIG. 2.

In embodiments in which dielectric 32 is a solid dielectric, bulb 22′ may be positioned in waveguide body 19′ by drilling or otherwise forming a channel 46 from the perimeter 20′ to the desired position of the bulb. The bulb may then be placed in the channel, or the void formed by the channel may be filled with the appropriate plasma-forming material, including any light emitter material. The channel may be sealed or blocked by insertion of a pedestal or rod 48 that is adhered to or fused to the body along the walls of the channel, as shown. One or more energy feeds 30 may be positioned in the base of rod 48, or other locations as appropriate. Bulb 22′ may thus be formed in dielectric 32, or it may be encased in an envelope or shell 50 embedded in the dielectric, or placed through a sufficiently wide channel 46. Shell 50 may be formed of any suitable light-transmissive, refractory dielectric material, such as quartz, alumina, zirconia, magnesia, or the like.

Bulb or bulbs 22′ may be positioned in any appropriate location within the intersection of waveguide 18′ and light-transmissive chamber 26′. For instance, an optional position for bulb 22′ is shown in dashed lines. Such positions may correspond to a location with a high-energy field, or may correspond to a position from which emitted light is readily focused or otherwise transmitted out of the waveguide and/or light-transmissive chamber.

An optional configuration for lamp 12′ is with either or both of the waveguide 18′ and light-transmissive chamber 26′ shaped as a full ellipsoid. In such an embodiment, the upper perimeter portions 20a′, 28a′ may have a shape approximately as represented by dashed lines in FIG. 2. In this example in which an ellipsoid shape is used, various ellipsoid shapes may be used, so the shape shown is for illustration purposes. As discussed previously, the locations of the energy feeds and bulbs may be selected based on the particular features and characteristics of the desired lamp. In some configurations, a bulb may be located at one or each of the two foci of the light-transmissive chamber. Energy feeds may then be placed to appropriately energize the bulb or bulbs.

An aperture may be located at one or both ends of the chamber in line with the two foci. For example, an aperture 40 is shown at the upper end of the chamber. Light emitted from an idealized point-sized bulb at one of the foci may tend to be reflected by the light shield through the other focus. Depending upon the angle of the light and the size and location of the aperture(s), the light may then be directly transmitted out of the chamber through an aperture, or reflected back and forth through the respective foci until the angle of the light is sufficiently aligned with an axis or line 51 passing through the foci that the light exits through an aperture.

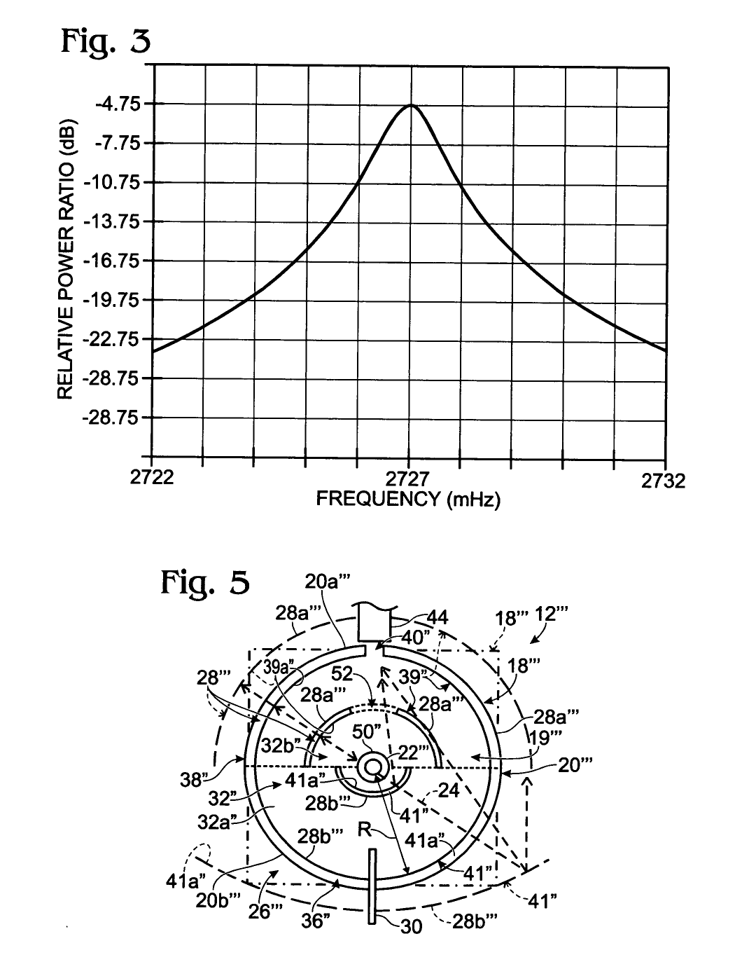

FIG. 3 illustrates the relative proportion of power coupled from an energy feed located near the center of an ellipsoid waveguide to an output probe located near alternate aperture 40 shown in FIG. 2, for frequencies in the range of 2722 megahertz (MHz) to 2732 MHz, with −4.75 dB forward transmission coefficient, representing the coupling of power from the input probe to the output probe. The waveguide used for these measurements has an approximately ellipsoid shape that is about five inches long and four inches wide, and has air as the dielectric. It is seen that resonance occurs at a center frequency of about 2727 MHz. Defining a quality factor, Q, as the ratio of the center frequency to the bandwidth (±3 dB), this waveguide has a Q≈2727 MHz/1.2 MHz≈2300 for the position of input and output probes used for measurement. This value may decrease when increased coupling to a bulb is provided, and may vary depending upon the positions of the energy feed(s) and bulb(s), and the frequency and amplitude of the applied electromagnetic energy. For example, by moving the output probe deeper into the microwave, there is increased coupling to the output probe (−1.4 dB), but reduced quality factor (about 270). In designing a lamp for use in a particular application, a balance between quality factor and coupling coefficient may be selected.

FIG. 4 illustrates another example of a plasma lamp, shown generally at 12″, having a waveguide 18″ and a coextensive light-transmissive chamber 26″. A perimeter 20″ of the waveguide may have an upper portion 20a″ having a substantially hemispherical shape, and a lower portion 20b″ having a modified ellipsoid or paraboloid shape. Electromagnetic energy may be transmitted into the waveguide through one or more energy feeds, such as energy feed 30. Light-transmissive chamber 26″ may have a similarly shaped perimeter 28″ with a hemispherical portion 28a″ and a non-spherical portion 28b″. Light-transmissive chamber 26″ is defined by a director 38′ including directing elements 39′ and 41′. Surfaces 39a′ and 41a′ of the respective directing elements 39′ and 41′ correspond to light chamber perimeter portions 28a″ and 28b″. A bulb 22″ may be positioned at the radial center C of portion 28a″, which position may also be a focal point of portion 28b″. It may also be appropriate to displace the bulb from a point of peak resonance.

Light transmitted from bulb 22″ initially directed toward portion 28a″ may be reflected back through the bulb 22″ toward portion 28b″. Light from the bulb directed toward portion 28b″ may be reflected toward an aperture 40′, as represented by light 24. In an embodiment in which upper portion 28a″ is not reflective of all light emitted from bulb 22″, such as when waveguide shield 36′ is formed of a mesh with multiple regularly spaced apertures 40′, perimeter portion 28b″, as shown by the segment as a dashed line, may be adapted to reflect light from the bulb in a parallel direction through portion 28a″, as shown by light 24′.

Waveguide 18″ may have a body 19″ filled with a gas, liquid and/or solid dielectric 32′ surrounded by a waveguide shield 38′. Bulb 22″ may be supported in the dielectric as was described for lamp 12′ shown in FIG. 2. Bulb 22″ may be contained within a shell 50′, which in turn may be supported on a dielectric supporting leg, pedestal or rod 48′, or other supporting device.

FIG. 5 illustrates yet further embodiments of a plasma lamp, shown generally at 12′″. In one embodiment depicted in FIG. 5, the entire perimeter 20′″ of a waveguide 18′″, including portions 20a′″ and 20b′″, may be spherical, with electromagnetic energy being input via an energy feed 30. This structure may be sized to produce electromagnetic energy resonance with a high Q when fed with energy of an appropriate frequency for a mode of resonance. In other embodiments, the waveguide may have other shapes. For instance, a waveguide 18′″ shown in dash-dot lines may be box-shaped or cylindrical.

A light-transmissive chamber 26′″ may take any of various forms, each of which may be defined, at least in part by a director 38″ including one or more directing elements, such as directing elements 39″ and 41″, that define perimeter 28′″. In these examples, the directing elements are reflectors, and may include respective surfaces 39a″ and 41a″. For example, the light-transmissive chamber may conform to the shape of the waveguide. However, due to the spherical shape of the perimeter 28′″, relatively little light may be conducted through an aperture 40″ with this embodiment.

In another example, upper perimeter portion 28a′″ may conform with an upper perimeter portion 20a′″ of the waveguide, as in the embodiments described with reference to FIGS. 2 and 4. Optionally, the partial-spherical perimeter portion 28a′″ may be supported within waveguide 18′″, as shown by the reduced-size perimeter portions 28a′″, optionally separated by a light aperture 52. Optionally, perimeter portion 28a′″ may be supported outside of the waveguide, as represented by the dashed lines. In this case, waveguide shield 36″ allows light to pass through multiple apertures 40″, as is characterized by a conductive mesh.

In other examples, lower portion 28b′″ of the light chamber perimeter may be positioned within waveguide 18′″ or outside waveguide 18′″, as shown. This lower portion then may have a shape that reflects light toward the aperture, or other selected direction. When lower portion 28b′″ is within the waveguide, a portion 32a″ of the waveguide dielectric 32″ below lower perimeter portion 28b′″ may or may not be transmissive of light. Any part of portion 32a″ of dielectric 32″ through which light is transmitted, accordingly may be included within light-transmissive chamber 26′″. Various other combinations of upper perimeter portions 28a and lower portions 28b also may be used.

Referring generally to the various embodiments shown in FIGS. 1, 2, 4 and 5, a light-transmissive chamber 26 may include regions bounded by respective light chamber perimeter portions 28a, perimeter portions 28b, and any associated light apertures, such as apertures 40 and 52. Similarly, to the extent that all or a portion of a waveguide may be coextensive with a light-transmissive chamber 26, then all or a portion of the coextensive portion of the waveguide body may be light-transmissive as well. The examples of waveguides and light-transmissive chambers shown are illustrative, it being possible to configure waveguides and light-transmissive chambers in a variety of ways to produce a plasma lamp 12. For example, more or fewer optical devices may be used for directing light produced by the one or more bulbs along different light paths to one or more apertures.

As has been mentioned, the coextensive portions of a waveguide 18 and a light-transmissive chamber 26 may be one or more of a gas dielectric, a liquid dielectric, and a solid dielectric, and may be partially or completely light transmissive. Accordingly, portions of a waveguide that are not coextensive with a light-transmissive chamber may also be one or more of a gas dielectric, a liquid dielectric, and a solid dielectric, and may or may not be light-transmissive. A waveguide body may be considered light transmissive so long as at least a portion of the body is light transmissive, whether made of a single dielectric or a combination of dielectrics.

Thus, while the present disclosure references the foregoing embodiments, many variations may be made without departing from the spirit and scope of the following claims. The foregoing embodiments are illustrative, and no single feature, procedure or element is essential to all possible combinations that may be claimed in this or a later application. Moreover, the description includes all novel and non-obvious combinations of elements described herein, and claims may be presented in this or a later application to any novel and non-obvious combination of these elements. Where the claims recite “an”, “a first”, or “another” element or the equivalent thereof, such claims include incorporation of one or more such elements, neither requiring nor excluding two or more such elements. Further, cardinal indicators, such as first, second or third, for identified elements are used to distinguish between the elements, do not indicate a required or limited number of such elements, and do not indicate a particular position or order of such elements unless otherwise specifically stated.

1. A lamp comprising:
a waveguide including a solid dielectric body, the body being substantially transmissive of light, the waveguide being configured to guide electromagnetic energy received from a source, and having at least one aperture adapted to allow light to exit the body; and
at least one bulb disposed in the body, the bulb being adapted to produce light when excited by the electromagnetic energy.

2. The lamp of claim 1, further comprising a director adapted to direct the produced light along a pathway through the light-transmissive body portion.

3. The lamp of claim 2, in which the director includes at least one directing element configured to direct light produced by the bulb toward the aperture.

4. The lamp of claim 3, in which the at least one directing element reflects light.

5. The lamp of claim 4, in which the director further comprises at least a second directing element configured to direct light produced by the bulb back toward the bulb.

6. The lamp of claim 3, in which the waveguide has a waveguide perimeter, and the at least one directing element is disposed one or more of (a) along at least a portion of the waveguide perimeter, (b) within the body, and (c) without the body.

7. The lamp of claim 3, in which the director has a substantially ellipsoid shape.

8. The lamp of claim 7, in which the director has two foci, and in which the one bulb is disposed at one of the foci.

9. The lamp of claim 8, in which the one aperture is generally disposed along a line passing through the two foci.

10. The lamp of claim 1, in which the waveguide further includes a plurality of apertures, and the lamp further comprises a director disposed outside of the waveguide and adapted to direct light that has exited the body.

11. The lamp of claim 10, in which the waveguide further includes an electric wave shield having uniformly distributed apertures.

12. The lamp of claim 11, in which the electric wave shield is a mesh.

13. The lamp of claim 1, in which the body is made of transparent dielectric material.

14. The lamp of claim 13, in which the body is made of one or more of sapphire, zirconia, and magnesia.

15. A lamp comprising:
a waveguide including a dielectric body, the waveguide being configured to guide electromagnetic energy received from a source, and having at least one aperture adapted to allow light to exit the body, the body having at least a portion that is transmissive of light;
at least one bulb disposed in the waveguide and adapted to produce light when excited by the electromagnetic energy; and
a director disposed in the waveguide, spaced from the bulb, and adapted to direct a first portion of the produced light through the light-transmissive body portion toward the at least one aperture.

16. The lamps of claim 15, in which the director is further adapted and to direct a second portion of the produced light back to the bulb.

17. The lamp of claim 16, wherein the director includes at least a first surface that reflects the first portion of the produced light, and at least a second surface that reflects the second portion of the produced light.

18. The lamp of claim 17, in which the waveguide has a perimeter, and at least one of the first and second surfaces is disposed one or more of (a) along at least a portion of the waveguide perimeter, and (b) within the body.

19. The lamp of claim 17, in which the first surface is disposed opposite from the at least one aperture from the bulb, and the second surface is disposed toward the at least one aperture from the bulb.

20. The lamp of claim 19, in which the second surface is a partial spherical surface having a center coincident with the bulb, and the first surface is a not a partial spherical surface.

21. The lamp of claim 20, in which the waveguide has a perimeter generally conforming to the first and second surfaces.

22. The lamp of claim 15, in which the director has a substantially ellipsoid shape.

23. The lamp of claim 22, in which the director has two foci, and the one bulb is disposed at one of the foci.

24. The lamp of claim 23, in which the one aperture is generally disposed along a line passing through the two foci.

25. A lamp comprising:
a waveguide having a substantially continuously curved perimeter with at least a non-partial spherical first portion, the waveguide being configured to guide electromagnetic energy received from a source, and having at least one aperture adapted to allow light to exit the waveguide; and
at least one bulb disposed in the waveguide and being adapted to produce light when excited by the electromagnetic energy, the waveguide and bulb configured to transmit light from the bulb to the at least one aperture.

26. The lamp of claim 25, in which the waveguide further includes a partial spherical second portion.

27. The lamp of claim 25, in which the at least one aperture is disposed in the second portion of the waveguide perimeter.

28. The lamp of claim 25, in which the waveguide includes a light-transmissive body, and the lamp further comprises a director disposed in the light-transmissive body, spaced from the bulb, and adapted to direct a first portion of light produced by the bulb along a pathway through the light-transmissive body toward the at least one aperture.

29. The lamp of claim 28, in which the director is further adapted to direct a second portion of the produced light back to the bulb.

30. The lamp of claim 29, wherein the director includes at least a first surface that reflects the first portion of the produced light, and at least a second surface that reflects the second portion of the produced light.

31. The lamp of claim 30, in which at least one of the first and second surfaces is disposed one or more of (a) along at least a portion of the waveguide perimeter, and (b) within the body.

32. The lamp of claim 30, in which the first surface is disposed opposite from the at least one aperture from the bulb, and the second surface is disposed toward the at least one aperture from the bulb.

33. The lamp of claim 38, in which the director has a substantially ellipsoid shape.

34. The lamp of claim 33, in which the director has two foci, and the one bulb is disposed at one of the foci.

35. The lamp of claim 34, in which the one aperture is generally disposed along a line passing through the two foci.

36. A method comprising:
receiving electromagnetic energy from a source within a waveguide having a solid dielectric body and at least one light-transmissive aperture;
guiding the received electromagnetic energy to a bulb disposed within the body with sufficient energy to produce light; and
transmitting light produced by the bulb through the body to the aperture.

37. The method of claim 36, further comprising directing the light produced by the bulb through the body.

38. The method of claim 37, in which directing the light produced by the bulb further includes directing at least a portion of the light produced by the bulb back toward the bulb.

39. The method of claim 37, in which directing the light produced by the bulb includes reflecting the light produced by the bulb.

40. The method of claim 39, in which the waveguide has a waveguide perimeter, and reflecting the produced light includes reflecting the produced light, one or more of (a) along at least a portion of the waveguide perimeter, (b) within the body, and (c) without the body.

41. The method of claim 36, in which transmitting light produced by the bulb includes transmitting throughout the body light produced by the bulb.

42. The method of claim 41, in which transmitting light produced by the bulb includes transmitting light produced by the bulb to the outside of the waveguide, and directing light that has been transmitted to the outside the waveguide.

43. The method of claim 42, in which transmitting light produced by the bulb outside of the waveguide includes transmitting light through uniformly distributed apertures.

44. A lamp comprising:
means for guiding electromagnetic energy within a given perimeter;
solid dielectric means for conducting guided electromagnetic energy and light within the given perimeter; and
means disposed in the solid dielectric means for converting electromagnetic energy into light.

45. The lamp of claim 44, further comprising means for directing the produced light along a pathway through the solid dielectric means.

46. The lamp of claim 45, in which the means for directing the produced light includes means for reflecting the produced light.

47. The lamp of claim 45, in which the means for directing the produced light is further for directing at least a portion of the light produced by the means for converting energy back toward the means for converting energy.

48. The lamp of claim 46, in which the means for reflecting is further for one or more of reflecting the light produced by the means for converting energy, (a) along at least a portion of the given perimeter, (b) within the solid dielectric means, and (c) without the solid dielectric means.

49. A lamp comprising:
a waveguide having a continuously curved perimeter and a solid dielectric, light-transmissive body, the waveguide being configured to guide electromagnetic energy received from a source, and having at least one aperture adapted to allow light to exit the waveguide;
at least one bulb disposed in the body, the bulb being adapted to produce light when excited by the electromagnetic energy; and
a director generally conforming to the waveguide, spaced from the bulb, and adapted to reflect light produced by the bulb.

50. The lamp of claim 49, in which the director and waveguide each include a first portion that is generally hemispherical in shape and a second portion that is generally partially ellipsoidal in shape.

51. The lamp of claim 50, in which the one bulb is positioned at at least one of a radial center of the first portion of the director and a focal point of the second portion of the director.

52. The lamp of claim 49, in which the director and waveguide are generally ellipsoidal in shape.

53. The lamp of claim 52, in which the one bulb is positioned at a focal point of the director.
